(19) United States
(12) Patent Application Publication
(10) Pub. No.: US 2024/0135309 A1
(43) Pub. Date: Apr. 25, 2024

(54) SYSTEMS AND METHODS FOR PROGRAMMATIC AND INTELLIGENT LOAD TRACKING AND MATCHING

(71) Applicant: Uber Technologies, Inc., San Francisco, CA (US)

(72) Inventors: Craig Kenneth Armstrong, Cohasset, MA (US); Jason Thomas Girouard, New York, NY (US); Megan Keith, Oak Park, IL (US)

(21) Appl. No.: 17/969,759

(22) Filed: Oct. 19, 2022

(51) Int. Cl. G06Q 10/08

(52) U.S. Cl. CPC G06Q 10/0834; G06Q 10/0833

(57) ABSTRACT

An operations computing system can assign loads to carriers when available by obtaining load data descriptive of one or more load attributes of a load; programmatically determining a status of a plurality of statuses for the load based on (i) the one or more load attributes and (ii) one or more status attribute criteria, the status attribute criteria being indicative of a relationship between values of the one or more load attributes and a respective status of the plurality of statuses; storing, in a load status data store, the status of the load; comparing the one or more load attributes and one or more transport conditions to carrier preferences associated with a plurality of candidate carriers; selecting a carrier of the plurality of candidate carriers based, at least in part, on the comparison of the one or more load attributes and the one or more transport conditions to the carrier preferences; and providing the one or more load attributes to the selected carrier.

### FIELD

The present disclosure relates generally to tracking and deriving the availability of shipment loads for intelligent matching of loads to carriers, with improved computational efficiency.

### BACKGROUND

Management of owner-operated freight vehicles can be complicated due to the complex nature of customer requirements and the need to convey information to the carriers (e.g., drivers) operating the vehicles. Operations computing systems provide various types of technological features for monitoring and tracking freight vehicles and performing other tasks related to the management of freight vehicles.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for automatically determining load status. The method includes obtaining, by a computing system including one or more computing devices, load data descriptive of one or more load attributes of a load; programmatically determining, by the computing system, a status of a plurality of statuses for the load based on (i) the one or more load attributes and (ii) one or more status attribute criteria, the status attribute criteria being indicative of a relationship between values of the one or more load attributes and a respective status of the plurality of statuses; storing, in a load status data store of the computing system, the determined status of the load; comparing, by the computing system, the one or more load attributes and one or more transport conditions to carrier preferences associated with a plurality of candidate carriers; selecting, by the computing system, a carrier of the plurality of candidate carriers based, at least in part, on the comparison of the one or more load attributes and the one or more transport conditions to the carrier preferences; and providing, by the computing system, the one or more load attributes to the selected carrier.

Another example aspect of the present disclosure is directed to a computing system including one or more processors and one or more non-transitory, computer-readable media storing instructions that, when implemented, cause the one or more processors to perform operations. The operations include obtaining load data descriptive of one or more load attributes of a load; programmatically determining a status of a plurality of statuses for the load based on (i) the one or more load attributes and (ii) one or more status attribute criteria, the status attribute criteria being indicative of a relationship between values of the one or more load attributes and a respective status of the plurality of statuses, storing, in a load status data store, the determined status of the load; comparing the one or more load attributes and one or more transport conditions to carrier preferences associated with a plurality of candidate carriers, selecting a carrier of the plurality of candidate carriers based, at least in part, on the comparison of the one or more load attributes and the one or more transport conditions to the carrier preferences, and providing the one or more load attributes to the selected carrier.

Yet another example aspect of the present disclosure is directed to one or more non-transitory, computer-readable media configured to store instructions that, when executed, cause a computing system to perform operations. The operations include obtaining load data descriptive of one or more load attributes of a load, programmatically determining a status of a plurality of statuses for the load based on (i) the one or more load attributes and (ii) one or more status attribute criteria, the status attribute criteria being indicative of a relationship between values of the one or more load attributes and a respective status of the plurality of statuses; storing, in a load status data store, the determined status of the load; comparing the one or more load attributes and one or more transport conditions to carrier preferences associated with a plurality of candidate carriers; selecting a carrier of the plurality of candidate carriers based, at least in part, on the comparison of the one or more load attributes and the one or more transport conditions to the carrier preferences; and providing the one or more load attributes to the selected carrier.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example operations computing system according to example implementations of the present disclosure.

FIG. 2 depicts an example load management interface for an operations computing system according to example implementations of the present disclosure.

FIG. 3 depicts example load data according to example implementations of the present disclosure.

FIG. 4 depicts a status state diagram according to example implementations of the present disclosure.

FIG. 5 depicts a flowchart diagram of an example method for automatically determining load status according to example implementations of the present disclosure.

FIG. 6 depicts a flowchart diagram of an example method for shipping a load with an operations computing system according to example implementations of the present disclosure.

FIGS. 7A-7B depicts flowchart diagrams of example methods for comparing load attributes to status attribute criteria according to example implementations of the present disclosure.

FIGS. 8A-8B depicts flowchart diagrams of an example methods for comparing load attributes to status attribute criteria according to example implementations of the present disclosure.

FIG. 9 depicts a block diagram of an example system for automatically determining load status according to example implementations of the present disclosure.

FIG. 10 depicts a block diagram of an example system for automatically determining load status according to example implementations of the present disclosure.

### DETAILED DESCRIPTION

Generally, the present disclosure is directed to automatically deriving statuses of loads in an operations computing system through automated assessment of underlying qualities of the loads, or load attributes, as well as deploying loads for transportation. A load can include one or more items/goods for transport by a carrier. Data descriptive of the load can be submitted by a computing device of a shipper, e.g., via the use of one or more APIs, to an operations computing system associated with the management of load transportation service (e.g., a network platform computing system). The operations computing system can use and store a plurality of statuses, where one or more statuses can be that are associated with the load, such as a created status, an available status, etc., that reflects a progress of the load from creation or submission to delivery.

Example aspects of the present disclosure provide systems and methods for automatically and intelligently determining load status, for improved matching and assignment of loads to a carrier. For instance, the operations computing system can the obtain or store load data descriptive of information for a load. The load can include, for example, a shipment of goods that a shipper (e.g., a customer of a load transportation service) wishes to have shipped. The data descriptive of the load can include load attributes. The load attributes can include characteristics of the loads, such as, for example, origin, destination, equipment type required for transporting the load, pickup time, dropoff time, commodity type, etc.

To improve the ability to match loads to and instruct a carrier, the operations computing system can intelligently evaluate certain attributes of the load before advancing the load to a particular progress status. For instance, the operations computing system can analyze the data descriptive of the load to determine that certain load attributes are present such as, for example, origin, destination, equipment requirements, etc. Additionally, or alternatively, the operations computing system can validate certain load attributes to ensure that the information is valid for various reasons (e.g., having incorrect information, having a pickup date that has already passed, etc).

According to example aspects of the present disclosure, the operations computing system can programmatically determine a status (e.g., an appropriate status) of a plurality of statuses for the load based on one or more load attributes and one or more status attribute criteria. For instance, the computing system can compare the load attributes to status attribute criteria that are indicative of a relationship between values of load attributes and a respective status. The status attribute criteria can be associated with (e.g., defined for) a particular load attribute or for a particular status. For instance, in some implementations, each status of the plurality of statuses may have a respective set of status attribute criteria. For example, a first status of the plurality of statuses can have a first respective set of status attribute criteria and a second status of the plurality of statuses can have a second respective set of status attribute criteria that differs from the first set of status attribute criteria. As an example, the requirements for a load to advance to a created status may be different from the requirements for a load to advance to the available status, and the sets of status attribute criteria can reflect that. For example, status attribute criteria relative to a created status may require that data is present or has been entered for each of one or more required load attributes or all load attributes. As another example, status attribute criteria can relate to valid data for the load attributes (e.g., specifying boundaries for numerical values, date ranges, text values, etc.). Based on the comparison of load attributes to status attribute criteria, the operations computing system can determine or assign an appropriate status to a load. For instance, if the load attributes for a load satisfy all the status attribute criteria, then the load can be assigned an available status, which indicates that the load is available to be assigned to a carrier. The carrier can then be provided information about the load (e.g., the load attributes) such that the carrier can complete the load.

If, however, a load does not satisfy the status attribute criteria, the load can be assigned an on-hold status, which indicates that availability of the load is pending correction of one or more invalid load attribute(s). Additionally, customers or operators of the operations computing system can be provided with detailed reasons as to why the load has been placed on-hold to facilitate correction of the invalid load attribute(s) and eventual availability of the load. For instance, if the load is assigned an on-hold status because it is missing data for a required load attribute, the load can be tagged with a description indicating which required load attribute(s) are missing. As another example, if the load has a pickup date that elapsed prior to the load being assigned to a carrier, the load can be assigned an on-hold status and the customer can be notified so that the customer can reschedule the load, modify the rate, or otherwise correct load attributes to return the load to the available status.

The operations computing system can automatically compute one or more transport conditions for a load based on the load attributes. To help compute the transport conditions, in some implementations, the operations computing system can analyze data from one or more other computing resources. The transport conditions can be indicative of certain qualities to be evaluated in order to advance the status of the load. The carrier transport conditions can also be useful for matching a load to a carrier as well as outputting instructions to the carrier for transporting the load. The transport conditions can include, for instance, estimated transit times based on map data, equipment requirements, or other conditions.

By way of example, the operations computing system can determine transit time(s) associated with one or more stages for transporting a load. The operations computing system can determine a loading time (e.g., the time it takes to securely place the load onto the truck of the carrier) based on the type of commodities in the load, the origin location, pickup time, or other load attributes. The operations computing system can determine the amount of shipment/carrier traffic at the particular origin location based on information stored within the system (e.g., tracking/logging data for other posted loads) or communication with one or more shipper computing systems that make such data available. Additionally, or alternatively, the operations computing system can also determine a transmit time for transporting the load from the origin to the destination based on a route analysis from the origin to the destination. In doing so, the operations computing system can take into account traffic data or weather available from a third-party computing source.

In another example, the operations computing system can compute an equipment condition associated with the load. To do so, the operations computing system can analyze the load attributes to determine if a shipper has submitted specific information indicating equipment that would be needed or helpful for transporting the load (e.g., loading/unloading from a trailer). Additionally, or alternatively, the operations computing system can analyze certain load attributes to predict what equipment may be needed or helpful. For example, the operations computing system can analyze the type of commodities to be transported, the packaging, weight, etc. to predict the equipment.

According to example aspects of the present disclosure, the operations computing system can programmatically determine a status of a plurality of statuses (e.g., an appropriate status) for the load based on (i) the one or more load attributes and (ii) one or more status attribute criteria. For instance, the computing system can compare the load attributes/transport conditions to status criteria that are indicative of a relationship between value of load attributes/transport conditions and a respective status. For example, status criteria relative to a created status may require that data is present or has been entered for each of one or more required load attributes or all load attributes. As another example, status criteria can be indicative of thresholds for certain transport conditions (e.g., transit times, equipment conditions). As another example, at least some status criteria can relate to the validity of the load attributes (e.g., specifying boundaries for numerical values, date ranges, text values, etc.).

Based on the comparison of load attributes/transport conditions to status criteria, the operations computing system can determine or assign an appropriate status to a load. For instance, if the load attributes for a load satisfy the applicable status criteria, then the load can be assigned an “available” status, which indicates that the load is available to be assigned to a carrier.

Once the load is associated with an “available” status, the operations computing system can match the load with a carrier and instruct the carrier accordingly. For example, the operations computing system can generate a carrier request including certain load attributes or transport conditions. The carrier request can be output to the respective computing device(s) associated with one or more carriers. For example, the operations computing system can utilize load attribute or transport conditions to identify certain carriers that may be more appropriate for transporting the load (e.g., due to equipment conditions) or more likely to accept the load. This can allow the operations computing system to leverage the intelligent analysis completed in advancing the status of the load in the system for improved matching of the load to a carrier.

Upon acceptance of the load request by a matched carrier, the operations computing system can generate and output instructions to a computing device associated the particular carrier. The instructions can include information about the load that will be helpful for the carrier in performing the transportation service. To help improve efficiency, the instructions can include information computed by the operations computing system during the automated status progression analysis. By way of example, the instructions can include estimated transit times, equipment conditions, etc.

If, however, a load does not satisfy the status criteria, the load can be assigned an on-hold status, which indicates that availability of the load is pending correction of some underlying load attribute. Additionally, customers or operators of the operations computing system can be provided with detailed reasons as to why the load has been placed on-hold to facilitate correction of the load attribute and eventual availability of the load. For instance, if the load is assigned an on-hold status because it is missing data for a required load attribute, the load can be tagged with a description indicating which required load attribute(s) are missing. As another example, if the load has a pickup date that elapsed prior to the load being assigned to a carrier, the load can be assigned an on-hold status and the customer can be notified so that the customer can reschedule the load, modify the rate, or otherwise correct load attributes to return the load to the available status.

Example aspects of the present disclosure are directed to systems and (e.g., computer-implemented) methods for automatically deriving a status associated with loads in an operations computing system. The systems and methods described herein can be implemented by any suitable systems such as computing systems including one or more computing devices. As one example, systems and methods described herein can be implemented by a computing system including one or more processors and one or more non-transitory, computer-readable media storing instructions that, when implemented, cause the one or more processors to perform operations that implement the methods, processes, or steps described herein.

After the carrier is assigned a load, the carrier can transport the load. Once the carrier has transported the load, the carrier can be provided with a user interface (e.g., on the carrier computing system) that facilitates the carrier notifying the operations computing system that the load has been completed. For instance, example aspects of the present disclosure can provide for receiving (e.g., by the computing system) an indication from the carrier computing system that the carrier has completed the load. The carrier can interact with a user interface (e.g., via one or more user input device(s) of a carrier computing system) to transmit the indication. The indication can be any suitable form of electronic indication, such as a system-based message, an email message, a data packet, or any other suitable form of indication. The indication from the carrier can include information about the load that has been completed, such as a load identifier, carrier identifier, or other information. In response to the receiving the indication that the carrier has completed the load, the operations computing system can advance the load to a completed status in the operations computing system. For instance, the operations computing system can assign the completed status to the load.

Example aspects of the present disclosure can provide a number of technical effects and benefits, including improvements to computing technology. For example, systems and methods according to example aspects of the present disclosure can improve computing technology by reducing computing resource usage directed to management of invalid or incomplete loads. As one example, systems and methods as described herein can provide for increased efficiency in transitioning loads through statuses, which can reduce a time that the load remains in the operations computing system before it is made available and subsequently completed. This reduced live time can allow loads to transition out of being actively managed sooner, such that the operations computing system can manage fewer active loads at a given time. This reduced number of active loads can, in turn, contribute to a lower amount of computing resources that must be dedicated to managing loads allowing those resources to be utilized on other computing tasks.

Additionally, the technology of the present disclosure improves the efficiency of the computational resources used for assignment loads to carriers. For instance, the technology described herein allows for better matching and assignment of loads to carriers. This can improve the likelihood of acceptance of a task to transport the load. As such, the computing system can reduce the frequency of having to create additional push notifications, requests, user interface updates, etc. to alternative find carriers. This allows the computing system to reduce its computational overhead per load and ultimately improve the efficiency with which it utilizes its processing, memory, and power resources.

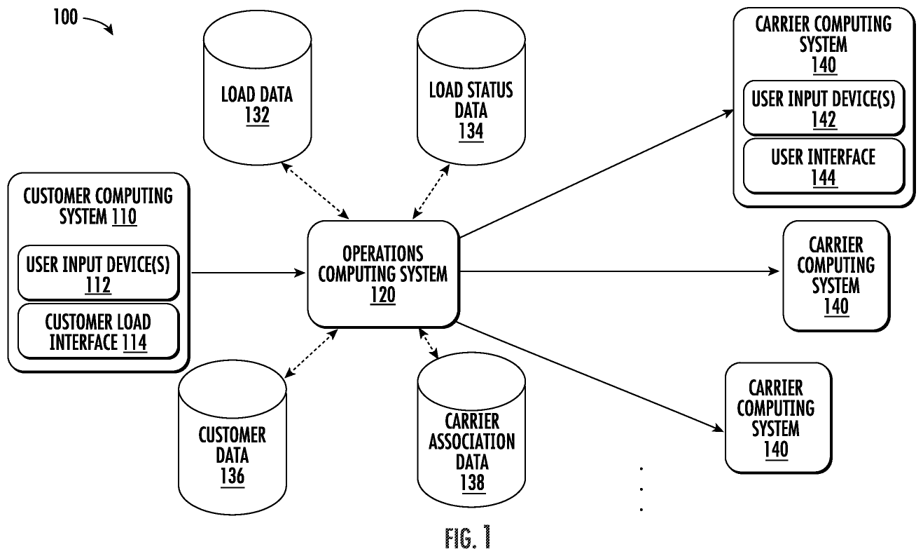

Referring now to FIGS. 1 through 10, example aspects of the present disclosure will be discussed in detail. It should be understood that various elements depicted in the Figures can be changed, modified, omitted, rearranged, or substituted without departing from the scope of the present disclosure.

FIG. 1 depicts a block diagram of an example system 100 for assigning loads to carriers according to example implementations of the present disclosure. System 100 can include operations computing system 120. Operations computing system 120 can provide various types of technological features for monitoring and tracking freight vehicles and performing other tasks related to the management of freight vehicles. For instance, operations computing system 120 can assign or assign loads from customers to one or more carriers for delivery in return for a rate associated with the load.

Operations computing system 120 can communicate with one or more customer computing system(s) 110 or one or more carrier computing system(s) 140. For instance, the operations computing system 120, the customer computing system(s) 110, or the carrier computing system(s) 140 can communicate over one or more network(s), such as Wi-Fi network(s), local area network(s) (LAN(s)), ethernet, cellular network(s), or any other suitable network(s).

Customer computing system 110 can be associated with a customer such as, for example, a shipper of a load. For example, a customer can create a profile or account associated with their loads on operations computing system 120 through customer computing system 110. The customer can then be provided with a customer load interface 114 facilitating input to customer computing system 100 through one or more user input device(s) 112. The customer can, through the customer load interface 114 or user input device(s) 112, input load data to the customer computing system 110. For instance, the load data can include load attributes such as an identifier of which shipment lane the load is associated with, pickup time, dropoff time, equipment type, etc. Although only one customer computing system 110 is illustrated in FIG. 1 for clarity, any suitable number of customer computing system(s) 110 can be included in system 100 or can be in communication with operations computing system 120.

The operations computing system 120 can read the load data from the customer computing system 110 to determine that the customer has added a new load to the operations computing system 120. The operations computing system can store the load data in load data store 132. The load data store 132 can be any suitable non-transitory, computer-readable media such as, for example, a cloud data storage server, a physical data storage server, a database, a databank, one or more hard drives or solid state drives, magnetic tape, or any other suitable form of data storage. The load data store 132 can be internal to or external from operations computing system 120.

Additionally, the operations computing system 120 can store an associated status for the loads in load data store 132. For instance, the statuses can be stored in load status data store 134. Although load status data store 134 is illustrated as being separate from operations computing system 120, it should be understood that the load status data store 134 may be included in a same medium as load data 132 or other data described herein. The load status data store 134 can be any suitable non-transitory, computer-readable media such as, for example, a cloud data storage server, a physical data storage server, a database, a databank, one or more hard drives or solid state drives, magnetic tape, or any other suitable form of data storage. The load status data store 134 can be internal to or external from operations computing system 120. As described herein, a status can be automatically determined or assigned to each load in load data store 132. Once the status has been determined, the status can be stored in load status data store 134. In some implementations, however, load status data store 134 can be a simple attribute of load data store 132. For instance, the status may be stored in load data store 132 as a separate data field.

In some implementations, once the status associated with a load is an available status, the operations computing system 120 can assign the load to a carrier in the operations computing system 120. For instance, example aspects of the present disclosure can provide for determining (e.g., by the computing system) that the appropriate status assigned to the load is an available status. For instance, the system can compare a data value indicating that the load is the available status (e.g., an alphanumerical status identifier) to a reference that corresponds to the available status. In response to determining that the appropriate status assigned to the load is the available status, example aspects of the present disclosure can provide for assigning (e.g., by the computing system) the load to a carrier in the operations computing system 120. For instance, if the appropriate status was not the available status but another status, such as, for example, the on-hold status, the created status, etc., the load may not be assigned to a carrier. The operations computing system 120 can store carrier association data that includes the assigned carrier for a respective load. The carrier association data can be stored in a separate carrier association data store (e.g., indexed by respective load or carrier) or stored as data associated with the load itself, such as metadata associated with a load, an additional load attribute (e.g., a carrier attribute), or in any other suitable fashion.

Once the status of the load is the available status, and the load is assigned to a carrier, that carrier can be provided with information from the operations computing system 120 to facilitate the carrier transporting the load. For instance, some or all of the one or more load attributes can be provided (e.g., transmitted) to a carrier computing system associated with the carrier such that the carrier can complete the load. As one example, the load attribute(s) can be transmitted over one or more network(s), such as a wireless network, and subsequently displayed or otherwise made available on the carrier computing system. The carrier can thus be made aware of needed information to transport the load, such as the load's origin, destination, required equipment type, etc. as well as other important information such as rate, etc. In some implementations, the carrier can request to be assigned to the load (e.g., by selecting the load on a list of loads). Additionally or alternatively, the carrier may be matched to the load based on carrier preferences, subscription to a shipping lane, or by any other suitable fashion for matching carriers to loads.

The operations computing system 120 can additionally store customer data 136. The customer data 136 can include data descriptive of customer information, such as a customer name, customer identifier, customer contact information, or other suitable data descriptive of attributes of the customer(s) using the operations computing system. Additionally or alternatively, the customer data 136 can include data associating a customer with loads (e.g., of load data 132) that belong to the customer, such as those loads created by the customer. As one example, the customer data 136 can include a list, table, or other associative data structure describing an ownership of loads by customers.

The operations computing system 120 can additionally store carrier association data 138. The carrier association data 138 can describe associations between carriers and loads. For instance, the carrier association data 138 can describe, for a given carrier, which load(s) the carrier is registered to carry. Additionally or alternatively, the carrier association data 138 can describe, for a given load, which carrier(s) are registered to transport the load. In some implementations, the carrier association data 138 can be a list, table, or other tabulated data format for storing associations between carriers and load(s).

The operations computing system 120 can communicate with one or more carrier computing systems 140. For instance, some or all carriers may have a carrier computing system 140 associated with the carrier. The carrier computing system 140 can be, for example, a user computing device such as a smartphone, tablet computer, laptop computer, a server computing system, a system onboard a carrier vehicle, or any other suitable computing system. The carrier computing system 140 can communicate with the operations computing system 120 to exchange information for managing the carriers or loads. For instance, the carrier computing system 140 can receive (e.g., based on user input at one or more user input devices 142), signals indicative of user input from the carrier. The user input can describe the carrier's interactions with various elements of a user interface 144 provided by the carrier computing system 140. For instance, the carrier can interact with the user interface 144 at the carrier computing system 140 such that the carrier computing system 140 determines that the carrier should be assigned a load. For example, the carrier may be presented with a user interface element providing for the carrier to request the load, such as a “register” button or similar element. Any suitable number of carrier computing system(s) 140 can be included in system 100 or can be in communication with operations computing system 120.

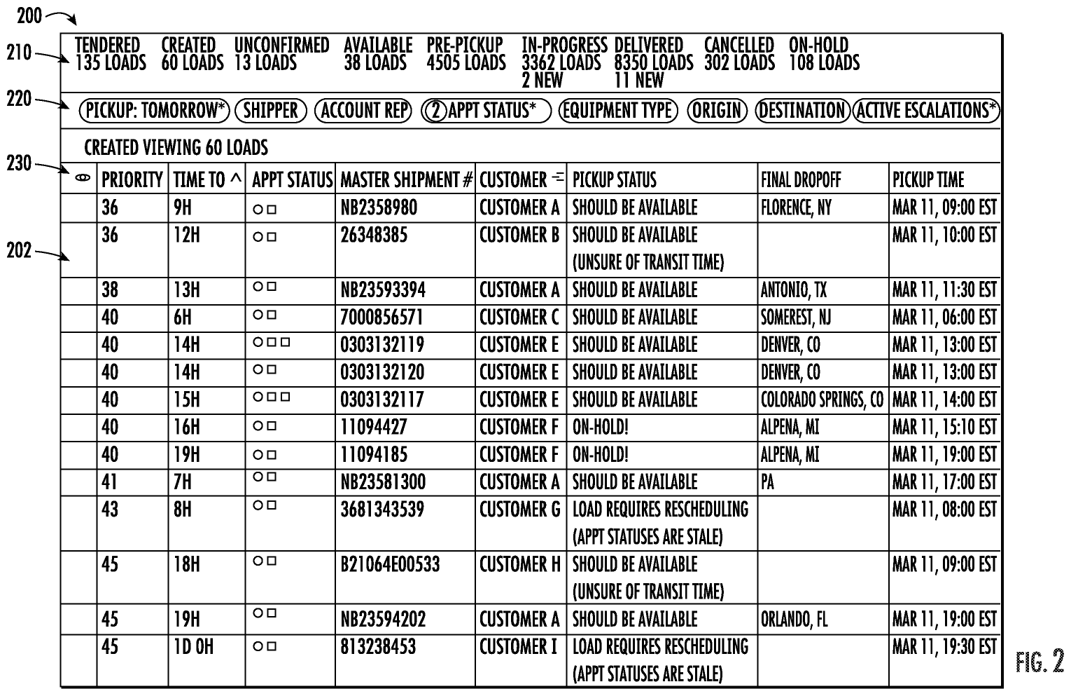

FIG. 2 depicts an example load management interface 200 for an operations computing system according to example implementations of the present disclosure. For instance, the example load management interface 200 can be presented to customers, carriers, or operators of operations computing system 120 of FIG. 1 or any other suitable operations computing systems. The load management interface 200 can display load attributes, identifiers, or other load data related to a plurality of loads 202 managed by the operations computing system. More or less information may be presented via load management interface 200 to different users of the operations computing system. For instance, customers may only be able to view or interact with loads that they have created in the operations computing system. Similarly, carriers may only be able to view or interact with available loads or loads that have been assigned to them. Operators may be able to view or interact with most or all loads in the operations computing system. Thus, load management interface 200 is one example of a load management interface that may be employed by an operations computing system in accordance with aspects of the present disclosure, but is not intended to be limiting.

The load management interface 200 can include one or more status filters 210. The status filters 210 can provide for a user to filter the loads 202 to a particular one or more statuses. For instance, a user may interact with a status filter 210 by clicking, hovering, or otherwise selecting a status filter 210 such that only loads 202 that have the corresponding status are displayed on load management interface 200. The load management interface 200 depicts status filters 210 for a tendered status, a created status, an unconfirmed status, an available status, a pre-pickup status, an in-progress status, a delivered status, a cancelled status, and an on-hold status, but more or fewer status filters 210 can be included according to example aspects of the present disclosure.

In addition to or alternatively to status filters 210, the load management interface 200 can include one or more attribute filters 220. The attribute filters 200 can provide for a user to filter the loads 202 based on particular values of load attributes. The attribute filters can provide for filtering by date, alphanumeric identifier, categorical identifier (e.g., a drop-down list), or other suitable values. For instance, the user can interact with attribute filters 220 by clicking, typing, hovering, or otherwise selecting or inputting data for an attribute filter 220 such that only loads 202 that have corresponding values for the selected load attribute(s) are displayed. As an example, in the interface 200, the user has selected attribute filters 220 such that only loads having one of two possible appointment statuses, a pickup date occurring tomorrow, and active escalations are displayed. Attribute filters 220 can be provided for any suitable load attribute(s), such as but not limited to origin, destination, customer, equipment type, loading type, geography type, load weight, commodity type, special requirements, customer type, rate, pickup time, or dropoff time.

As illustrated in FIG. 2, the load management interface 200 can display at least some load attributes 230 for the plurality of loads 202. The interface 200 displays, for example, a priority attribute, a time to pickup counter, an appointment status attribute, a load identifier, a customer identifier, a load status, a dropoff region or destination, and a pickup time for each load 202. More, fewer, or different load attributes can be displayed on a load management interface in accordance with example aspects of the present disclosure. Furthermore, as illustrated in FIG. 2, the pickup status column can display detailed information about load status, indicating availability or detailed reasons why the load is not available if it should be. For instance, the loads from customer F have been placed on-hold and are indicated as such, while the loads from customer G and I, which have stale appointment statuses, require rescheduling and are thus on-hold. Thus, a user viewing interface 200 can quickly and easily ascertain information about the loads 202.

FIG. 3 depicts example load data 300 according to example implementations of the present disclosure. Load data 300 includes a plurality of load attributes that may be stored for a given load by an operations computing system, such as operations computing system 120 of FIG. 1 (e.g., in load data store 132). Additionally or alternatively, a load management interface, such as load management interface 200 of FIG. 2, can be configured to display the load attributes stored in load data 300. As illustrated, for example, in FIG. 3, load data 300 includes a plurality of load attributes including a load identifier, an origin, a customer or shipper, a destination, an equipment type, a loading type, a geography type, a load weight, a commodity type, a customer type, a rate, special requirements, pickup time, and dropoff time. Load data 300 is provided as one example of load data that can be used by systems and methods as described herein, and is not intended to be limiting.

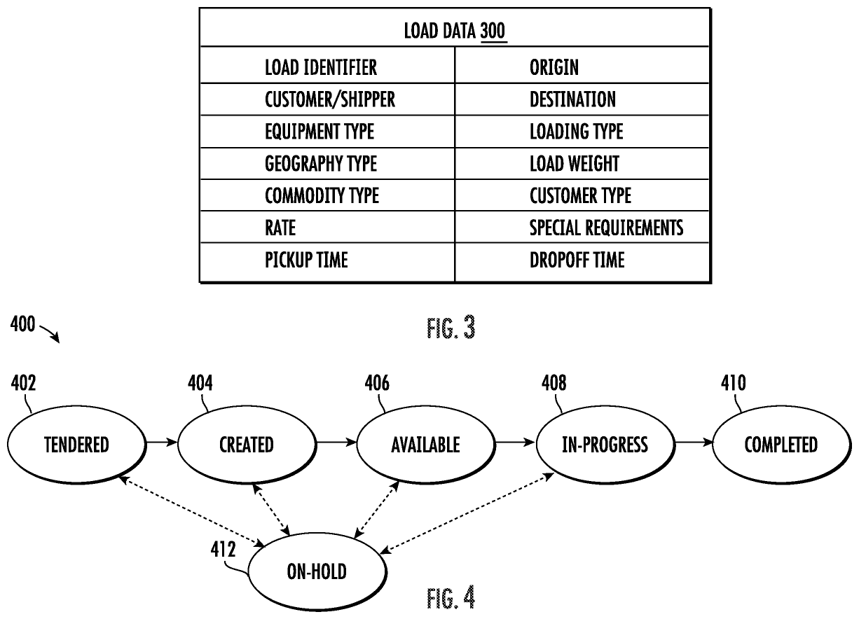

FIG. 4 depicts a status state diagram 400 according to example implementations of the present disclosure. An operations computing system, such as operations computing system 120 of FIG. 1, can be configured to advance a load through a plurality of statuses according to status state diagram 400. The status state diagram 400 includes example states such as tendered state 402, created state 404, available state 406, in-progress state 408, and completed state 410, along with optional on-hold state 412. It should be understood that any number or types of states can be included according to example aspects of the present disclosure, including more, fewer, or alternative states, without departing from the present disclosure.

Example status state diagram 400 includes tendered state 402. Tendered state 402 can correspond to a load that has been assigned an identifier in a load management system, but has not yet been created. For instance, loads assigned to the tendered state 402 may lack data for necessary load attributes, such as pickup time, pickup region, dropoff region, etc. Additionally, status state diagram 400 includes created state 404. Created state 404 can correspond to a load that has been assigned an identifier and for which the customer that created the load has input data for all load attributes which require data. However, the values of those load attributes may or may not be invalid (e.g., from user error, system error, etc.) and the validity of that data has not yet been confirmed. After the validity of that data is confirmed, the load would then be advanced, according to example aspects of the present disclosure, to the available status 406. The available status 406 indicates that the underlying load attributes representing the load are valid, and the load is ready to be assigned to a carrier for eventual transport. Once the load has been assigned to the carrier, the load may be advanced to the in-progress status 408. The in-progress status 408 can indicate that the carrier has been assigned the load and no further action is needed on the part of the operations computing system. Once the carrier has successfully completed the load, the carrier can communicate with the operations computing system to advance the load to the completed status 410.

If, however, the status of the load deviates from this progression, through data entry error, delays, postponement by carrier or customer, or for any other reason, the load may instead be assigned to the on-hold status 412. The on-hold status can generally indicate, for any of various reasons, that the load cannot advance through the status state diagram 400. Entities responsible for managing the load, such as operators of the operations computing system, the customer, or the carrier may appropriately be provided with detailed information about why the load has moved to the on-hold status 412. As one example, the entities may receive an indication that the load has missing attributes in required fields. As another example, the entities may receive an indication that a scheduled pickup time for the load has already elapsed. The load attributes can then be corrected or updated to return the load to one of the progression statuses 402-410.

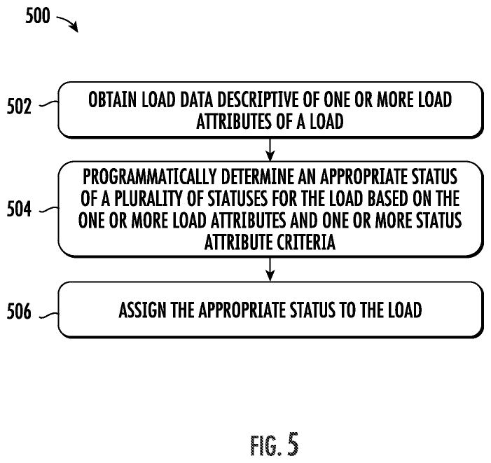

FIG. 5 depicts a flowchart diagram of an example method 500 for automatically determining load status according to example implementations of the present disclosure. One or more portions of the method 500 can be implemented by one or more computing devices such as, for example, the computing devices described herein. Moreover, one or more portions of the method can be implemented as an algorithm on the hardware components of the device(s) described herein FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method can be implemented by one or more computing devices.

The method 500 can include, at 502, obtaining (e.g., by a computing system including one or more computing devices) load data descriptive of one or more load attributes of load(s) managed by an operations computing system. For instance, in some cases, a computing system can access a load data store that stores the load data. The load data store can be indexed by a load identifier that is unique to each load. The load identifier can be, for example, an alphanumerical identifier, a serial number, a randomly-generated identifier, a customer-specific identifier, or any other suitable identifier. Additionally or alternatively, obtaining the load data can include receiving, from a customer computing system associated with a customer, the load data descriptive of the one or more load attributes. For instance, the customer may enter data for load attributes through a customer load interface at the customer computing system. The customer computing system can provide the customer with one or more user input device(s) that facilitate the customer entering data for the one or more load attributes. The customer computing system can collect the load data and transmit the load data (e.g., via one or more network(s)) to an operations computing system. In this way, a customer computing system can provide load data such that the operations computing system can receive the load data. Example load attributes can include, but are not limited to, origin, destination, customer, equipment type, loading type, geography type, load weight, commodity type, special requirements, customer type, rate, pickup time, or dropoff time.

The operations computing system can be configured to advance the load through a plurality of statuses indicative of a relationship between values of the one or more load attributes and a respective status of the plurality of statuses. For instance, each of the statuses can represent a relative progress of the load from its inception to its eventual completion and delivery. Example statuses in the plurality of statuses can include, but are not limited to, a tendered status, a created status, an available status, an in-progress status, a completed status, or an on-hold status. It should be understood that more, fewer, or different statuses can be used in accordance with example aspects of the present disclosure.

As one example, an initial status of a load created in the operations computing system may be a tendered status, indicating that the load has been tendered to the entity responsible for the operations computing system but the load attributes have not been filled out. For instance, the load may be assigned an identifier or associated customer, but may not yet have details for customer-input load attributes such as origin, destination, pickup time, etc. As another example, the operations computing system can assign a created status to loads. The created status can indicate that the customer tendering the load has input at least some data for at least some load attributes. Additionally or alternatively, the created status can indicate that the customer has indicated in some manner that data for the load attributes has been entered, such as by interacting with a “submit” or similar element on a user interface that provides for the customer to input data for load attributes.

Additionally or alternatively, the operations computing system can assign an available status to a load. The available status can indicate that the load is available to be assigned to a carrier. For instance, the load may be available to be assigned to the carrier if data is present for at least a subset of the load attributes (e.g., for all required load attributes). Additionally or alternatively, the load may be available to be assigned to the carrier if the data is valid for the load attributes. If, however, the data is not present or valid for the load attributes, the load may instead be assigned to an on-hold status. For instance, according to example aspects of the present disclosure, the load attributes can be compared to status attribute criteria to automatically determine whether the load should have an available status. Example aspects of the present disclosure can be especially beneficial for the transition between the created status and the available status, which can conventionally require expensive or time-consuming manual review. An available load can be assigned to a carrier, at which point the load advances to an in-progress status. For instance, the carrier may be provided with the ability to select a load for carrying or may automatically be assigned the load, as described herein. Once the carrier has carried the load and the operations computing system receives confirmation (e.g., from the carrier, from the destination of the load, etc.) the load may be advanced to a completed status. The load data for the completed load may be stored for recording purposes.

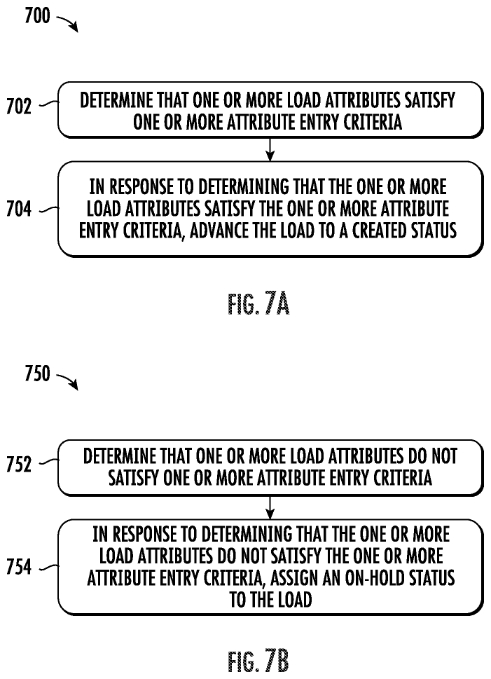

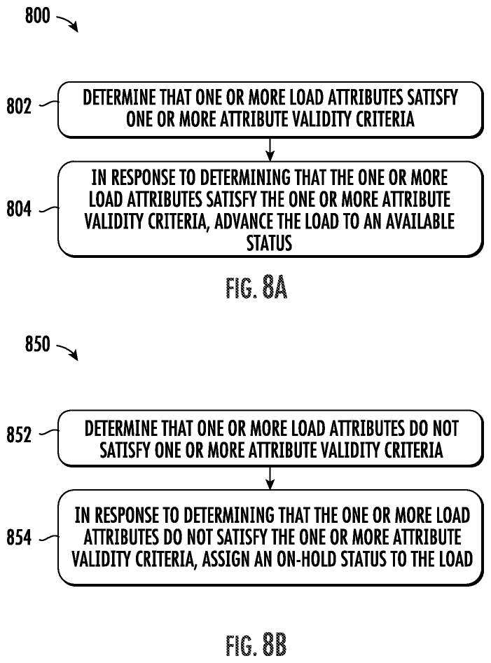

The method 500 can include, at 504, programmatically determining (e.g., by the computing system) an appropriate status of a plurality of statuses for the load based on (i) the one or more load attributes and (ii) one or more status attribute criteria. For instance, programmatically determining an appropriate status for the load can include comparing (e.g., by the computing system) the one or more load attributes to one or more status attribute criteria respective to the plurality of statuses. Based on the comparison of the one or more load attributes to the one or more status attribute criteria, the computing system can determine an appropriate status of the plurality of statuses for the load. The status attribute criteria can define criteria such as load attribute entry criteria requiring data to have been entered for a respective load attribute or attribute validity criteria indicative of a validity of entered data for a respective load attribute. If, based on the comparison, the load attribute satisfies one or more (e.g., all) of the status attribute criteria, the load can be advanced to a respective status that is specified by which status attribute criteria have or have not been satisfied. Examples of comparing the one or more load attributes to one or more status attribute criteria are discussed in greater detail with reference to methods 700 and 800 of FIGS. 7 and 8, respectively.

In some implementations, the comparison of the one or more load attributes to the one or more status attribute criteria is performed in response to an event wherein the load data is modified. For instance, an event listener in the load data store can listen for events wherein the load data is modified, such as by a customer modifying the load data. Thus, the system can determine the appropriate status for the load after each update. This can provide that the status is up-to-date in corresponding with the most recent set of load attributes. Furthermore, this approach can avoid expending computing resources on loads that have not been updated for some time. Additionally or alternatively, the comparison of the one or more load attributes to the one or more status attribute criteria can be performed at a periodic or semi-periodic interval (e.g., daily, weekly, hourly, etc.). Thus, if a load attribute that was previously valid at the last time the load data was updated has become invalid, through the passage of time (e.g., a pickup time that has now elapsed), updated constraints, or other reason, the status can be updated to reflect the most current validity.

The method 500 can include, at 506, assigning (e.g., by the computing system) the appropriate status to the load in the operations computing system. Assigning the appropriate status to the load can include storing, in a load status data store, the determined (e.g., programmatically-determined status of the load. For instance, the operations computing system can store load status data that includes the assigned status for a respective load. The load status data can be stored in a separate load status data store (e.g., indexed by respective load) or stored as data associated with the load itself, such as metadata associated with a load, an additional load attribute (e.g., a status attribute), or in any other suitable fashion.

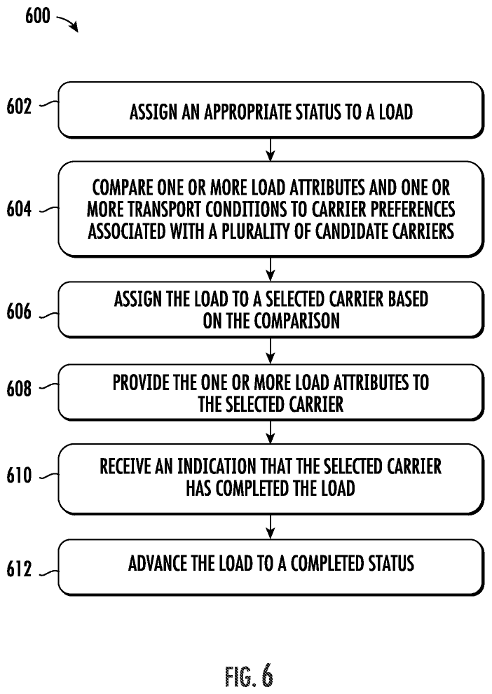

FIG. 6 depicts a flowchart diagram of an example method 600 for shipping a load with an operations computing system according to example implementations of the present disclosure. One or more portion(s) of the method 600 can be implemented by one or more computing devices such as, for example, the computing devices described herein. Moreover, one or more portion(s) of the method can be implemented as an algorithm on the hardware components of the device(s) described herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method can be implemented by one or more computing devices.

The method 600 can include, at 602, assigning (e.g., by a computing system) an appropriate status to a load in an operations computing system. Assigning the appropriate status to the load can include storing, in a load status data store, the determined (e.g., programmatically-determined) status of the load. For instance, the operations computing system can store load status data that includes the assigned status for a respective load. The load status data can be stored in a separate load status data store (e.g., indexed by respective load) or stored as data associated with the load itself, such as metadata associated with a load, an additional load attribute (e.g., a status attribute), or in any other suitable fashion. For instance, one example method for determining and assigning an appropriate status to a load is discussed with reference to method 500 of FIG. 5.

The method 600 can include, at 604, determining that the appropriate status assigned to the load is an available status. For instance, the system can compare a data value indicating that the load is the available status (e.g., an alphanumerical status identifier) to a reference that corresponds to the available status. In response to determining that the appropriate status assigned to the load is the available status, the method 600 can include, at 606, assigning (e.g., by the computing system) the load to a carrier in the operations computing system. The operations computing system can store carrier association data that includes the assigned carrier for a respective load. The carrier association data can be stored in a separate carrier association data store (e.g., indexed by respective load or carrier) or stored as data associated with the load itself, such as metadata associated with a load, an additional load attribute (e.g., a carrier attribute), or in any other suitable fashion. If, for instance, the appropriate status was not the available status but another status, such as, for example, the on-hold status, the created status, etc., the load may not be assigned to a carrier.

The method 600 can include, at 608, providing the one or more load attributes to the carrier. The carrier can be provided with information from the operations computing system to facilitate the carrier transporting the load. For instance, some or all of the one or more load attributes can be provided (e.g., transmitted) to a carrier computing system associated with the carrier such that the carrier can complete the load. As one example, the load attribute(s) can be transmitted over one or more network(s), such as a wireless network, and subsequently displayed or otherwise made available on the carrier computing system. The carrier can thus be made aware of needed information to transport the load, such as the load's origin, destination, required equipment type, etc. as well as other important information such as rate, etc. In some implementations, the carrier can request to be assigned to the load (e.g., by selecting the load on a list of loads). Additionally or alternatively, the carrier may be matched to the load based on carrier preferences, subscription to a shipping lane, or by any other suitable fashion for matching carriers to loads.

After the carrier is assigned a load, the carrier can transport the load. Once the carrier has transported the load, the carrier can be provided with a user interface (e.g., on the carrier computing system) that facilitates the carrier notifying the operations computing system that the load transport has been completed. The method 600 can then include, at 610, receiving an indication from the carrier computing system that the carrier has completed the load. The carrier can interact with a user interface (e.g., via one or more user input device(s) of a carrier computing system) to transmit the indication. The indication can be any suitable form of electronic indication, such as a system-based message, an email message, a data packet, or any other suitable form of indication. The indication from the carrier can include information about the load that has been completed, such as a load identifier, carrier identifier, or other information. The method 600 can include, at 612, in response to the receiving the indication that the carrier has completed the load, advancing the load to a completed status in the operations computing system. For instance, the operations computing system can assign the completed status to the load.

FIG. 7A depicts a flowchart diagram of an example method 700 for comparing load attributes to status attribute criteria according to example implementations of the present disclosure. One or more portions of the method 700 can be implemented by one or more computing devices such as, for example, the computing devices described herein. Moreover, one or more portions of the method can be implemented as an algorithm on the hardware components of the device(s) described herein. FIG. 7A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method 700 can be implemented by one or more computing devices.

The method 700 can include, at 702, determining (e.g., by a computing system) that one or more load attributes satisfy one or more attribute entry criteria. The one or more attribute entry criteria can be included in one or more status attribute criteria. The one or more attribute entry criteria can require data to have been entered for a respective load attribute of one or more load attributes. In some implementations, data may be required for all load attributes, but in some implementations only a subset of the load attributes may require data, per the one or more attribute entry criteria. For example, it may be desirable to require data for some (e.g., more-critical) load attributes, such as pickup time, origin, destination, etc. without requiring data be entered for some optional or less critical attributes, such as, for example, special requirements or geography type.

The method 700 can include, at 704, in response to determining that the one or more load attributes satisfy the one or more attribute entry criteria, advancing (e.g., by the computing system) the load to a created status. For instance, the load can be considered to have been created once data is at least present in each load attribute that requires data for formation of the load. The data may not necessarily be valid if the system has checked only the attribute entry criteria. For instance, the method 700 may initially be performed when a new load has been created in an operations computing system.

FIG. 7B depicts a flowchart diagram of an example method 750 for comparing load attributes to status attribute criteria according to example implementations of the present disclosure. One or more portions of the method 750 can be implemented by one or more computing devices such as, for example, the computing devices described herein. Moreover, one or more portions of the method can be implemented as an algorithm on the hardware components of the device(s) described herein. FIG. 7B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method 750 can be implemented by one or more computing devices.

The method 750 can include, at 752, determining, by the computing system, that the one or more load attributes do not satisfy the one or more attribute entry criteria. For instance, if an attribute entry criteria associated with the created status specifies that data must be present in a particular attribute (e.g., pickup time) for the load to advance to created status, and a load does not have data for the particular attribute (e.g., a null or non-entered pickup time), then the system may determine that the load attributes do not satisfy the attribute entry criteria.

The method 750 can include, at 754, in response to determining that the one or more load attributes do not satisfy the one or more attribute entry criteria, assigning, by the computing system, an on-hold status to the load and storing an on-hold reason based on the one or more load attributes that do not satisfy the one or more attribute entry criteria. For instance, the on-hold status can be assigned to indicate that the load is not in acceptable condition to advance to the created status. Details about why the load has not satisfied the attribute entry criteria, such as which load attributes require but do not have entered data, can be stored along with the on-hold status (e.g., in the load status data store) such that a message can be provided to users of the operations computing system indicating why the load has not advanced.

FIG. 8A depicts a flowchart diagram of an example method 800 for comparing load attributes to status attribute criteria according to example implementations of the present disclosure. One or more portions of the method 800 can be implemented by one or more computing devices such as, for example, the computing devices described herein. Moreover, one or more portions of the method can be implemented as an algorithm on the hardware components of the device(s) described herein. FIG. 8A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method 800 can be implemented by one or more computing devices.

The method 800 can include, at 802, determining (e.g., by a computing system) that one or more load attributes satisfy one or more attribute validity criteria. The one or more attribute validity criteria can be included in one or more status attribute criteria. The one or more attribute validity criteria can be indicative of a validity of data entered for a respective load attribute. As one example, an attribute validity criteria may specify, for a given load attribute, a range or set of data values for that load attribute which are considered valid. For example, for a load attribute that specifies a range of dates or times, such as a pickup time attribute, the attribute validity criteria can specify a range of dates or times of day which are valid pickup times, such as a pickup time that has elapsed, a pickup time occurring reasonably within business hours, or other suitable dates/times. As another example, for categorical load attributes, such as a commodity type attribute, the attribute validity criteria can specify that the data values for that attribute must match a list or format of allowable inputs (e.g., a list of allowable commodity types).

The method 800 can include, at 854, in response to determining that the one or more load attributes satisfy the one or more attribute validity criteria, advancing, by the computing system, the load to an available status. For instance, once the load has been created and has valid values for all required load attributes, the load can be considered to be ready for pickup. In this way, the load can be assigned to carriers without requiring extensive manual review.

FIG. 8B depicts a flowchart diagram of an example method 850 for comparing load attributes to status attribute criteria according to example implementations of the present disclosure. One or more portions of the method 850 can be implemented by one or more computing devices such as, for example, the computing devices described herein. Moreover, one or more portions of the method can be implemented as an algorithm on the hardware components of the device(s) described herein. FIG. 8B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The method 850 can be implemented by one or more computing devices.

The method 850 can include, at 852, determining (e.g., by a computing system) that one or more load attributes do not satisfy one or more attribute validity criteria. For instance, if an attribute validity criteria associated with the available status specifies that data must fall within a certain set of allowed values for a particular attribute (e.g., a pickup time that occurs in the future) for the load to advance to available status, and the load data includes, for that attribute, a value that falls outside of the set of allowed values (e.g., a pickup time that has already elapsed), then the system may determine that the load attributes do not satisfy the attribute validity criteria.

The method 850 can include, at 854, in response to determining that the one or more load attributes do not satisfy the one or more attribute validity criteria, assigning, by the computing system, an on-hold status to the load and storing an on-hold reason based on the one or more load attributes that do not satisfy the one or more attribute validity criteria. For instance, the on-hold status can be assigned to indicate that the load is not in acceptable condition to advance to the available status. Details about why the load has not satisfied the attribute entry criteria, such as which load attributes have invalid data, a list of allowable values, etc., can be stored along with the on-hold status (e.g., in the load status data store) such that a message can be provided to users of the operations computing system indicating why the load has not advanced.

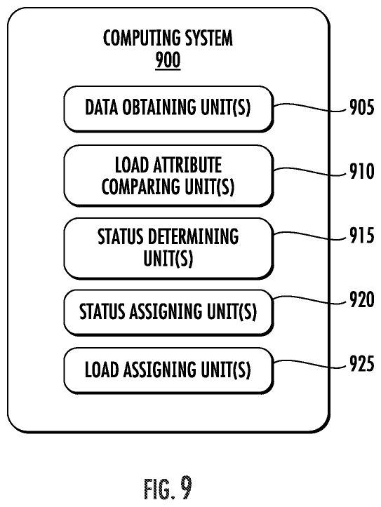

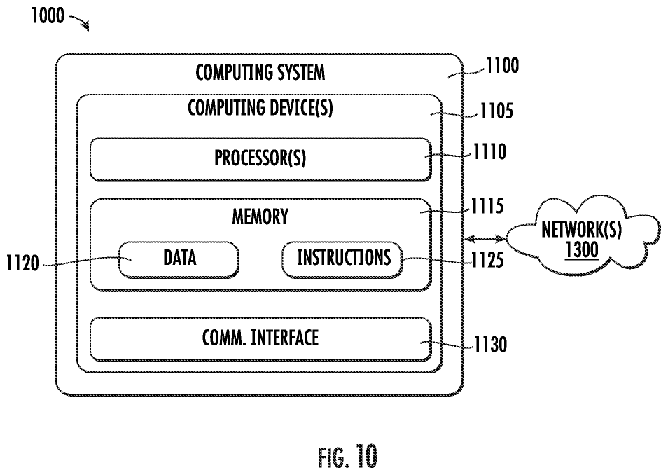

FIG. 9 depicts a block diagram of an example system 900 for automatically determining load status according to example implementations of the present disclosure. Various means can be configured to perform the methods and processes described herein. FIG. 9 depicts example units associated with a computing system for performing operations and functions according to example embodiments of the present disclosure. As depicted, FIG. 9 depicts a computing system 900 that can include, but is not limited to, data obtaining unit(s) 905; load attribute comparing unit(s) 910; status determining unit(s) 915; status assigning unit(s) 920; or load assigning unit(s) 925. In some implementations one or more units may be implemented separately. In some implementations, one or more units may be included in one or more other units.

In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware. The means can be programmed to perform one or more algorithm(s) for carrying out the operations and functions described herein.

The means can be configured to obtain load data descriptive of one or more load attributes of a load managed by an operations computing system, wherein the operations computing system is configured to advance the load through a plurality of statuses indicative of a relationship between values of the one or more load attributes and a respective status of the plurality of statuses. A data obtaining unit 905 is one example of a means for obtaining load data descriptive of one or more load attributes of a load managed by an operations computing system according to example aspects of the present disclosure.

The means can be configured to compare the one or more load attributes to one or more status attribute criteria respective to the plurality of statuses. A load attribute comparing unit 910 is one example of a means for comparing the one or more load attributes to one or more status attribute criteria respective to the plurality of statuses according to example aspects of the present disclosure.

The means can be configured to, based on the comparison of the one or more load attributes to the one or more status attribute criteria, determine an appropriate status of the plurality of statuses for the load. A status determining unit 915 is one example of a means for determining an appropriate status of the plurality of statuses for the load based on the comparison of the one or more load attributes to the one or more status attribute criteria according to example aspects of the present disclosure.

The means can be configured to assign the appropriate status to the load in the operations computing system. Assigning the appropriate status to the load can include storing, in a load status data store, the appropriate status of the load. A status assigning unit 920 is one example of a means for assigning the appropriate status to the load in the operations computing system according to example aspects of the present disclosure.

FIG. 10 depicts a block diagram of an example computing system 1000 according to example embodiments of the present disclosure. The example system 1000 includes a computing system 1100 that can be communicatively coupled to one or more remote computing systems (not illustrated) over one or more networks 1300.

The computing system 1105 can include one or more processors 1110 and a memory 1115. The one or more processors 1110 can be any suitable processing device (e.g., a processor core, a microprocessor, an ASIC, a FPGA, a controller, a microcontroller, etc.) and can be one processor or a plurality of processors that are operatively connected. The memory 1115 can include one or more non-transitory computer-readable storage media, such as RAM, ROM, EEPROM, EPROM, one or more memory devices, flash memory devices, etc., and combinations thereof.

The memory 1115 can store information that can be accessed by the one or more processors 1110. For instance, the memory 1115 (e.g., one or more non-transitory computer-readable storage mediums, memory devices) can store data 1120 that can be obtained, received, accessed, written, manipulated, created, or stored. The data 1120 can include, for instance, data such as load attributes, criteria, status data, freight lanes, carrier information, etc. as described herein. In some implementations, the computing system 1100 can obtain data from one or more memory device(s) that are remote from the computing system 1100.

The memory 1115 can also store computer-readable instructions 1125 that can be executed by the one or more processors 1120. The instructions 1125 can be software written in any suitable programming language or can be implemented in hardware. Additionally, or alternatively, the instructions 1125 can be executed in logically or virtually separate threads on processor(s) 1110.

For example, the memory 1115 can store instructions 1125 that when executed by the one or more processors 1110 cause the one or more processors 1110 (the computing system) to perform any of the operations or functions described herein, including, for example, obtaining load data descriptive of one or more load attributes of a load managed by an operations computing system, wherein the operations computing system is configured to advance the load through a plurality of statuses indicative of a relationship between values of the one or more load attributes and a respective status of the plurality of statuses; comparing the one or more load attributes to one or more status attribute criteria respective to the plurality of statuses; based on the comparison of the one or more load attributes to the one or more status attribute criteria, determining an appropriate status of the plurality of statuses for the load; and assigning the appropriate status to the load in the operations computing system.

The computing system 1100 can include a communication interface 1130. The communication interface 1130 can be used to communicate with one or more systems or devices, including systems or devices that are remotely located from the computing system 1100. A communication interface 1130 can include any circuits, components, software, etc. for communicating with one or more networks (e.g., 1300). In some implementations, a communication interface 1130 can include, for example, one or more of a communications controller, receiver, transceiver, transmitter, port, conductors, software or hardware for communicating data.

The network(s) 1300 can be any type of network or combination of networks that allows for communication between devices. In some embodiments, the network(s) can include one or more of a local area network, wide area network, the Internet, secure network, cellular network, mesh network, peer-to-peer communication link or some combination thereof and can include any number of wired or wireless links. Communication over the network(s) 1300 can be accomplished, for instance, via a network interface using any type of protocol, protection scheme, encoding, format, packaging, etc.

FIG. 10 illustrates one example computing system 1000 that can be used to implement the present disclosure. Other computing systems can be used as well. In addition, components illustrated or discussed as being included in one of the computing systems 1100 can instead be included in any other suitable computing system. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

What is claimed is:

1. A computer-implemented method comprising:
obtaining, by a computing system comprising one or more computing devices, load data descriptive of one or more load attributes of a load;
programmatically determining, by the computing system, a status of a plurality of statuses for the load based on (i) the one or more load attributes and (ii) one or more status attribute criteria, the status attribute criteria being indicative of a relationship between values of the one or more load attributes and a respective status of the plurality of statuses;
storing, in a load status data store of the computing system, the determined status of the load;
comparing, by the computing system, the one or more load attributes and one or more transport conditions to carrier preferences associated with a plurality of candidate carriers;
selecting, by the computing system, a carrier of the plurality of candidate carriers based, at least in part, on the comparison of the one or more load attributes and the one or more transport conditions to the carrier preferences; and
providing, by the computing system, the one or more load attributes to the selected carrier.

2. The computer-implemented method of claim 1, wherein obtaining the load data comprises receiving, from a customer computing system associated with a customer, the load data descriptive of the one or more load attributes.

3. The computer-implemented method of claim 1, further comprising:
receiving, by the computing system, an indication from the selected carrier that the selected carrier has completed the load; and
in response to the receiving the indication that the selected carrier has completed the load, advancing, by the computing system, the load to a completed status.

4. The computer-implemented method of claim 1, wherein the plurality of statuses comprises at least one of a tendered status, a created status, an available status, an in-progress status, a completed status, or an on-hold status.

5. The computer-implemented method of claim 1, wherein programmatically determining, by the computing system, the status of the plurality of statuses for the load comprises:
determining, by the computing system, that the one or more load attributes satisfy one or more attribute entry criteria of the one or more status attribute criteria, the one or more attribute entry criteria requiring data to have been entered for a respective load attribute of the one or more load attributes; and
in response to determining that the one or more load attributes satisfy the one or more attribute entry criteria, advancing, by the computing system, the load to a created status.

6. The computer-implemented method of claim 5, further comprising:
determining, by the computing system, that the one or more load attributes do not satisfy the one or more attribute entry criteria; and
in response to determining that the one or more load attributes do not satisfy the one or more attribute entry criteria, assigning, by the computing system, an on-hold status to the load and storing an on-hold reason based on the one or more load attributes that do not satisfy the one or more attribute entry criteria.

7. The computer-implemented method of claim 5, further comprising:
determining, by the computing system, that the one or more load attributes satisfy one or more attribute validity criteria of the one or more status attribute criteria, the one or more attribute validity criteria indicative of a validity of data entered for a respective load attribute; and
in response to determining that the one or more load attributes satisfy the one or more attribute validity criteria, advancing, by the computing system, the load to an available status.

8. The computer-implemented method of claim 7, further comprising:
determining, by the computing system, that the one or more load attributes do not satisfy the one or more attribute validity criteria; and
in response to determining that the one or more load attributes do not satisfy the one or more attribute validity criteria, assigning, by the computing system, an on-hold status to the load and storing an on-hold reason based on the one or more load attributes that do not satisfy the one or more attribute validity criteria.

9. The computer-implemented method of claim 1, wherein the one or more load attributes comprise at least one of: an origin, a destination, a customer, an equipment type, a loading type, a geography type, a load weight, a commodity type, special requirements, a customer type, a rate, a pickup time, or a dropoff time.

10. The computer-implemented method of claim 1, wherein the one or more transport conditions comprise one or more of transit time, equipment conditions, or loading time.

11. A computing system comprising:
one or more processors; and
one or more non-transitory, computer-readable media storing instructions that, when implemented, cause the one or more processors to perform operations comprising:
obtaining load data descriptive of one or more load attributes of a load;
programmatically determining a status of a plurality of statuses for the load based on (i) the one or more load attributes and (ii) one or more status attribute criteria, the status attribute criteria being indicative of a relationship between values of the one or more load attributes and a respective status of the plurality of statuses;
storing, in a load status data store, the determined status of the load;
comparing the one or more load attributes and one or more transport conditions to carrier preferences associated with a plurality of candidate carriers;
selecting a carrier of the plurality of candidate carriers based, at least in part, on the comparison of the one or more load attributes and the one or more transport conditions to the carrier preferences; and
providing the one or more load attributes to the selected carrier.

12. The computing system of claim 11, wherein the operations further comprise:
receiving an indication from the selected carrier that the selected carrier has completed the load; and
in response to the receiving the indication that the selected carrier has completed the load, advancing the load to a completed status in the transport management system.

13. The computing system of claim 11, wherein programmatically determining the status of the plurality of statuses for the load comprises:
determining that the one or more load attributes satisfy one or more attribute entry criteria of the one or more status attribute criteria, the one or more attribute entry criteria requiring data to have been entered for a respective load attribute of the one or more load attributes; and
in response to determining that the one or more load attributes satisfy the one or more attribute entry criteria, advancing the load to a created status.

14. The computing system of claim 13, wherein the operations further comprise:
determining that the one or more load attributes do not satisfy the one or more attribute entry criteria; and
in response to determining that the one or more load attributes do not satisfy the one or more attribute entry criteria, assigning an on-hold status to the load and storing an on-hold reason based on the one or more load attributes that do not satisfy the one or more attribute entry criteria.

15. The computing system of claim 13, wherein the operations further comprise:
determining that the one or more load attributes satisfy one or more attribute validity criteria of the one or more status attribute criteria, the one or more attribute validity criteria indicative of a validity of data entered for a respective load attribute; and
in response to determining that the one or more load attributes satisfy the one or more attribute validity criteria, advancing the load to an available status.

16. The computing system of claim 15, wherein the operations further comprise:
determining that the one or more load attributes do not satisfy the one or more attribute validity criteria; and
in response to determining that the one or more load attributes do not satisfy the one or more attribute validity criteria, assigning an on-hold status to the load and storing an on-hold reason based on the one or more load attributes that do not satisfy the one or more attribute validity criteria.

17. One or more non-transitory, computer-readable media configured to store instructions that, when executed, cause a computing system to perform operations comprising:
obtaining load data descriptive of one or more load attributes of a load;
programmatically determining a status of a plurality of statuses for the load based on (i) the one or more load attributes and (ii) one or more status attribute criteria, the status attribute criteria being indicative of a relationship between values of the one or more load attributes and a respective status of the plurality of statuses;
storing, in a load status data store, the determined status of the load;
comparing the one or more load attributes and one or more transport conditions to carrier preferences associated with a plurality of candidate carriers;
selecting a carrier of the plurality of candidate carriers based, at least in part, on the comparison of the one or more load attributes and the one or more transport conditions to the carrier preferences; and
providing the one or more load attributes to the selected carrier.

18. The non-transitory, computer-readable media of claim 17, wherein the operations further comprise:
receiving an indication from the selected carrier that the selected carrier has completed the load; and
in response to the receiving the indication that the selected carrier has completed the load;
advancing the load to a completed status in the transport management system.

19. The non-transitory, computer-readable media of claim 17, wherein programmatically determining the status of the plurality of statuses for the load comprises:
determining that the one or more load attributes satisfy one or more attribute entry criteria of the one or more status attribute criteria, the one or more attribute entry criteria requiring data to have been entered for a respective load attribute of the one or more load attributes; and
in response to determining that the one or more load attributes satisfy the one or more attribute entry criteria, advancing the load to a created status.

20. The non-transitory, computer-readable media of claim 18, wherein the operations further comprise:
determining that the one or more load attributes satisfy one or more attribute validity criteria of the one or more status attribute criteria, the one or more attribute validity criteria indicative of a validity of data entered for a respective load attribute; and
in response to determining that the one or more load attributes satisfy the one or more attribute validity criteria, advancing the load to an available status.
